(19) United States
(12) Patent Application Publication
(10) Pub. No.: US 2018/0039638 A1
(43) Pub. Date: Feb. 8, 2018

(54) SYSTEM AND METHOD FOR PRESENTING RELATED RESOURCES IN IMAGE SEARCHES

(71) Applicant: YANDEX EUROPE AG, Luzern (CH)

(72) Inventors: Dmitrii Sergeyevich KRIVOKON, Salekhard, Tumen region (RU); Pavel Alekseevich SHISHKIN, Samara region, Samara (RU); Oleg Sergeevich POPOV, Moscow (RU); Ilnur Flurovich GADELSHIN, Ufa, Baskortostan (RU); Mikhail Alexandrovich SUKHOV, Moscow (RU); Andrii Aleksandrovich MELNIKOV, Kiev (UA); Anton Pavlovich ARTEMOV, Moscow (RU)

(21) Appl. No.: 15/552,436

(22) PCT Filed: May 22, 2015
(86) PCT No.: PCT/IB2015/053760

§ 371 Date: Aug. 21, 2017

(30) Foreign Application Priority Data
Feb. 27, 2015 (RU) 2015106797

(51) Int. Cl. G06F 17/30

(52) U.S. Cl. CPC G06F 17/3064; G06F 17/30265; G06F 17/30864

(57) ABSTRACT

There is disclosed a method and a system for processing an image-based search suggestion for a first search query. The method is executable at a server. The method comprises receiving the first search query from an electronic device associated with a user; generating a plurality of image-based search suggestions related to the first search query, the image-based search suggestions being based at least partially on past related search queries; ranking the plurality of image-based search suggestions using a first and a second set of ranking parameters to render a first and a second ranked list of image-based search suggestions, respectively; and generating a ranked list of image-based search suggestions by selecting a first portion and a second portion from the first and second ranked list, respectively. The first and second sets of ranking parameters are associated with, respectively, a frequency parameter and a hidden interest parameter.

### CROSS-REFERENCE

The present application claims priority to Russian Patent Application No. 2015106797, filed Feb. 27, 2015, entitled “A SYSTEM AND METHOD FOR PRESENTING RELATED RESOURCES IN IMAGE SEARCHES” the entirety of which is incorporated herein.

### FIELD

The present technology relates to search engines in general and specifically to a method and apparatus for processing an image-based search suggestion for a search query.

### BACKGROUND

Various global or local communication networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

Generally speaking, a given user can access a resource on the communication network by two principle means. The given user can access a particular resource directly, either by typing an address of the resource (typically an URL or Universal Resource Locator, such as www.webpage.com) or by clicking a link in an e-mail or in another web resource. Alternatively, the given user may conduct a search using a search engine to locate a resource of interest. The latter is particularly suitable in those circumstances, where the given user knows a topic of interest, but does not know the exact address of the resource she is interested in.

For example, the given user may be interested in viewing pictures of Macaulay Culkin, but may not be aware of a particular resource that would present such information. Alternatively, the given user may be interested in locating the closest Starbucks coffee shop, but again may not be aware of a particular web resource to provide such location services. In these fictitious (yet practical) circumstances, the given user may run a web search using the search engine.

When the given user runs a web search using the search engine, he or she generally has two priorities. He or she wants the search engine to locate the most relevant results and he or she wants the results relatively quickly. To at least partially address these concerns, it is known to present the user using a search engine with query suggestions. For example, in response to a user typing a query “Macaulay” into the Google™ search engine, the user gets a list of suggestions in a drop down menu, namely “Macaulay Culkin”, “Macaulay Culkin movies”, etc. The general idea behind the suggestions is to enable a more user-friendly search experience and to assist the user in exploring a subject of interest. For example, the user may not know exactly what query will provide the information he or she wants; search suggestions can help the user to find desired or related information. The user then can browse the search results and select a link that he or she is desirous of perusing.

U.S. Pat. No. 8,370,337 issued on Feb. 5, 2013 to Kanungo et al. teaches methods and computer-storage media for generating a machine-learned model for ranking search results using click-based data. Data is referenced from user queries, which may include search results generated by general search engines and vertical search engines. A training set is generated from the search results and click-based judgments are associated with the search results in the training set. Based on click-based judgments, identifiable features are determined from the search results in a training set. Based on determining identifiable features in a training set, a rule set is generated for ranking subsequent search results. In some cases, human-based judgments associated with one or more search results in the training set are used along with the click-based judgments to generate the rule set.

U.S. Patent Application Publication No. 2014/0129493 published on May 8, 2014 to Leopold teaches a method and system for visualizing complex data via a multi-agent query engine. A user interface is provided for inputting a query, generating a query result including one or more matching concepts stored in a knowledgebase of one or more media types, and presenting the user with a rich personalized query result based on the user's preferences and personal information, and providing improved relevant search results. In some cases, a topic analyzer extracts one or more topics from the query. Topic analyzer may analyze the topics extracted from received queries in real-time to identify trends.

U.S. Pat. No. 8,661,029 issued on Feb. 25, 2014 to Kim et al. teaches systems and techniques for modifying search result ranking based on implicit user feedback. A computer-implemented method determines a measure of relevance for a document result within a context of a search query for which the document result is returned, the determining being based on a first number in relation to a second number, the first number corresponding to longer views of the document result, and the second number corresponding to at least shorter views of the document result; and outputting the measure of relevance to a ranking engine for ranking of search results, including the document result, for a new search corresponding to the search query.

### SUMMARY

It is an object of the present technology to ameliorate at least some of the inconveniences present in the prior art.

In one aspect, implementations of the present technology provide a method of processing an image-based search suggestion for a first search query. The method can be executable at a server. The method comprises: receiving the first search query from an electronic device associated with a user; generating a plurality of image-based search suggestions related to the first search query, the image-based search suggestions being based at least partially on past related search queries; ranking the plurality of image-based search suggestions using a first set of ranking parameters to render a first ranked list of image-based search suggestions and a second set of ranking parameters to render a second ranked list of image-based search suggestions; and generating a ranked list of image-based search suggestions by selecting a first portion from the first ranked list of image-based search suggestions and a second portion from the second ranked list of image-based search suggestions.

The first set of ranking parameters have been trained on a first training set of image-based search suggestions associated with a frequency parameter indicative of how often the image-based search suggestions for the first search query have been associated with past user searching behavior.

The second set of ranking parameters have been trained on a second training set of image-based search suggestions associated with a hidden interest parameter indicative of the high relevancy for the user of the image-based search suggestions irrespective of the associated frequency parameter.

In another aspect, implementations of the present technology provide a method further comprising, before selecting the first portion from the first ranked list of image-based search suggestions, selecting a first subset of image-based search suggestions from the first ranked list, the first subset including only indirectly-linked image-based search suggestions from the first ranked list; and generating the ranked list of image-based search suggestions by selecting the first portion from the first subset of image-based search suggestions from the first ranked list.

In another aspect, implementations of the present technology provide a system for processing an image-based search suggestion for a first search query, the system comprising a server. The server comprises a communication interface for communication with an electronic device associated with a user via a communication network; a memory storage; and a processor operationally connected with the communication interface and the memory storage. The processor is configured to store objects, in association with the user, on the memory storage. The processor is further configured to: receive a first search query from the electronic device; generate a plurality of image-based search suggestions related to the first search query, the image-based search suggestions being based at least partially on past related search queries; rank the plurality of image-based search suggestions using a first set of ranking parameters to render a first ranked list of image-based search suggestions and a second set of ranking parameters to render a second ranked list of image-based search suggestions; and generate a ranked list of image-based search suggestions by selecting a first portion from the first ranked list of image-based search suggestions and a second portion from the second ranked list of image-based search suggestions. The first set of ranking parameters have been trained on a first training set of image-based search suggestions associated with a frequency parameter indicative of how often the image-based search suggestions for the first search query have been associated with past user searching behavior. The second set of ranking parameters have been trained on a second training set of image-based search suggestions associated with a hidden interest parameter indicative of the high relevancy for the user of the image-based search suggestions irrespective of the associated frequency parameter.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram depicting a system, the system being implemented in accordance with non-limiting embodiments of the present technology.

FIG. 2 is a schematic representation of the electronic device of the system of FIG. 1, the electronic device being implemented in accordance with non-limiting embodiments of the present technology.

FIG. 3 depicts a block diagram of a method, the method being executable within the system of FIG. 1 and being implemented in accordance with non-limiting embodiments of the present technology.

FIG. 4 depicts a block diagram of a method, the method being executable within the system of FIG. 1 and being implemented in accordance with non-limiting embodiments of the present technology.

FIG. 5 depicts a block diagram of a method, the method being executable within the system of FIG. 1 and being implemented in accordance with non-limiting embodiments of the present technology.

### DETAILED DESCRIPTION

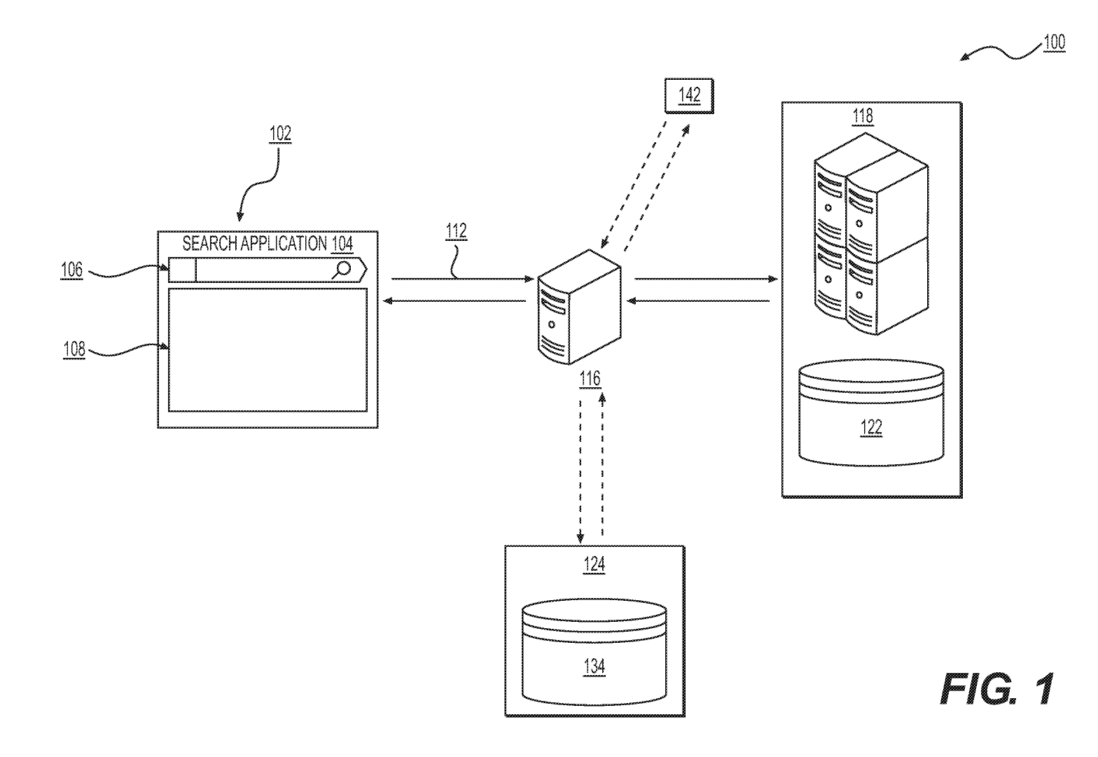

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

Generally speaking, the system 100 is configured to receive search queries and to conduct general and vertical searches in response thereto, as well as to process search queries in accordance with non-limiting embodiments of the present technology. As such, any system variation configured to process user search queries can be adapted to execute embodiments of the present technology, once teachings presented herein are appreciated.

The system 100 comprises an electronic device 102. The electronic device 102 is typically associated with a user (not depicted) and, as such, can sometimes be referred to as a “client device”. It should be noted that the fact that the electronic device 102 is associated with the user does not need to suggest or imply any mode of operation—such as a need to log in, a need to be registered, or the like.

The implementation of the electronic device 102 is not particularly limited, but as an example, the electronic device 102 may be implemented as a personal computer (desktops, laptops, netbooks, etc.), a wireless communication device (such as a smartphone, a cell phone, a tablet and the like), as well as network equipment (such as routers, switches, and gateways). The electronic device 102 comprises hardware and/or software and/or firmware (or a combination thereof), as is known in the art, to execute a search application 104. Generally speaking, the purpose of the search application 104 is to enable the user (not depicted) to execute a search, such as the above mentioned web search using the above-mentioned search engine.

How the search application 104 is implemented is not particularly limited. One example of the search application 104 may include a user accessing a web site associated with a search engine to access the search application 104. For example, the search application can be accessed by typing in an URL associated with Yandex™ search engine at www.yandex.ru. It should be expressly understood that the search application 104 can be accessed using any other commercially available or proprietary search engine.

In alternative non-limiting embodiments of the present technology, the search application 104 may be implemented as a browser application on a portable device (such as a wireless communication device). For example (but not limited to) those implementations, where the electronic device 102 is implemented as a portable device, such as for example, Samsung™ Galaxy™ SIII, the electronic device may be executing a Yandex browser application. It should be expressly understood that any other commercially available or proprietary browser application can be used for implementing non-limiting embodiments of the present technology.

Generally speaking, the search application 104 comprises a search query interface 106 and a search result interface 108. The general purpose of the search query interface 106 is to enable the user (not depicted) to enter his or her query or a “search string”. The general purpose of the search result interface 108 is to provide search results that are responsive to the user search query entered into the search query interface 106. How the user search query is processed and how the search results are presented will be described in detail herein below.

Also coupled to the communication network is a server 116. The server 116 can be implemented as a conventional computer server. In an example of an embodiment of the present technology, the server 116 can be implemented as a Dell™ PowerEdge™ Server running the Microsoft™ Windows Server™ operating system. Needless to say, the server 116 can be implemented in any other suitable hardware, software, and/or firmware, or a combination thereof. In the depicted non-limiting embodiments of the present technology, the server 116 is a single server. In alternative non-limiting embodiments of the present technology, the functionality of the server 116 may be distributed and may be implemented via multiple servers.

The electronic device 102 is configured to communicate with the server 116 over a communication link 112. Generally speaking, the communication link 112 enables the electronic device 102 to access the server 116 via a communication network (not depicted). In some non-limiting embodiments of the present technology, the communication network (not depicted) can be implemented as the Internet. In other embodiments of the present technology, the communication network (not depicted) can be implemented differently, such as any wide-area communication network, local-area communication network, a private communication network and the like.

How the communication link 112 is implemented is not particularly limited and will depend on how the communication device 102 is implemented. Merely as an example and not as a limitation, in those embodiments of the present technology where the electronic device 102 is implemented as a wireless communication device (such as a smartphone), the communication link 102 can be implemented as a wireless communication link (such as but not limited to, a 3G communication network link, a 4G communication network link, Wireless Fidelity, or WiFi® for short, Bluetooth® and the like). In those examples where the communication device 102 is implemented as a notebook computer, the communication link can be either wireless (such as Wireless Fidelity, or WiFi® for short, Bluetooth® or the like) or wired (such as an Ethernet based connection).

The server 116 is communicatively coupled (or otherwise has access) to a search cluster 118. According to these embodiments of the present technology, the search cluster 118 performs general searches in response to the user search queries inputted via the search query interface 106 and outputs search results to be presented to the user using the search results interface 108. Within these non-limiting embodiments of the present technology, the search cluster 118 comprises or otherwise has access to a database 122. As is known to those of skill in the art, the database 122 stores information associated with a plurality of resources potentially accessible via the communication network (for example, those resources available on the Internet). The process of populating and maintaining the database 122 is generally known as “crawling”. It should be expressly understood that in order to simplify the description presented herein below, the configuration of the search cluster 118 has been greatly simplified. It is believed that those skilled in the art will be able to appreciate implementational details for the search cluster 118 and for components thereof.

The server 116 is further communicatively coupled (or otherwise has access) to a vertical search module 124. In the depicted non-limiting embodiment of the present technology, the vertical search module 124 is a single vertical search module. In alternative non-limiting embodiments of the present technology, the server 116 is communicatively coupled (or otherwise has access) to a plurality of vertical search modules (not depicted). For example, merely for the purposes of ease of illustration, vertical search module 124 is implemented as a vertical search module for searching images. Additional vertical search modules for searching additional vertical domains, for example maps and other geographical information, weather-related information, movies and the like, may be included. It should be expressly understood that a number of additional or different services can be implemented as part of the plurality of vertical search modules (not depicted), and that the number of modules within the plurality of vertical search modules is not meant to be limited.

For the various examples to be provided herein below, it shall be assumed that the vertical search module 124 is implemented as a vertical search module for images.

In the depicted non-limiting embodiment of the present technology, vertical search module 124 comprises or has access to one or more database 134. In alternative non-limiting embodiments of the present technology having a plurality of vertical search modules (not depicted), it should be understood that any given one of the plurality of vertical search modules (not depicted) comprises or has access to one or more databases (not depicted). These one or more databases host data associated with the particular services implemented by the given one of the plurality of vertical search modules (not depicted).

To the extent that vertical search module 124 has access to database 134, recalling that the vertical search module 124 implements images, the database 134 contains images and related information.

Additionally or optionally and, as known to those skilled in the art, the one or more database 134 may be segregated into one or more separate databases (not depicted). These segregated databases may be portions of the same physical database or may be implemented as separate physical entities. For example, one database within, let's say, the database 134 could host the most popular/most frequently requested images for a given subject, while another database within the database 134 could host all the images available. Needless to say, the above has been provided as an illustration only and several additional possibilities exist for implementing embodiments of the present technology.

The vertical search module 124 is configured to perform vertical searches within the database 134. However, it should be noted that the search capabilities of the vertical search module 124 is not limited to searching the respective database 134 and the vertical search module 124 may perform other searches, as the need may be.

Also, for the purposes of the description presented herein, the term “vertical” (as in vertical search) is meant to connote a search performed on a subset of a larger set of data, the subset having been grouped pursuant to an attribute of data. For example, to the extent that the vertical search module 124 is implemented as an images vertical service, the vertical search module 124 searches a subset (i.e., images) of the set of data (i.e., all the data potentially available for searching), the subset of data being stored in the database 134.

Within these embodiments of the present technology, the server 116 is configured to access, separately and independently, the search cluster 118 (to perform a general web search, for example) and the vertical search module 124 (to perform the vertical search of images, for example). In alternative non-limiting embodiments of the present technology, the vertical search module 124 can be implemented as part of the search cluster 118. In those embodiments, the search cluster 118 can be responsible for coordinating and executing both the general web search and the vertical search. In some embodiments of the present technology, the search cluster 118 can execute a multi layer meta search by executing both the general web and the vertical searches.

Within the embodiment depicted in FIG. 1, the server 116 is generally configured to (i) conduct searches (by accessing the search cluster 118 and/or vertical search module 124); (ii) execute analysis of search results and perform ranking of search results; (iii) group search results and compile the search result page (SERP) to be outputted to the electronic device 102.

According to non-limiting embodiments of the present technology, the server 116 is further configured to process an image-based search suggestion for the user entering a search query into the search query interface 106. As is known to one skilled in the art, search suggestion is a feature whereby, responsive to the user entering a search query or a portion of a search query, the search application 104 provides search suggestions related to the search query. For example, where the user has started typing in: “Macaulay Culkin”, possible search suggestions may include “Macaulay Culkin movies”, “Macaulay Culkin band”, “Macaulay Culkin wife” and the like. In accordance with embodiments of the present technology, the server 116 is configured to generate “image-based suggestions”. In some embodiments, the image-based suggestions can be “image-based query completion suggestions”. In alternative embodiments, the image-based suggestions can be “image-based related query suggestions”.

To that end, the server 116 comprises or has access to a suggest module 142. The operation of the suggest module 142 within the context of processing an image-based search suggestion for a search query according to non-limiting embodiments of the present technology will now be described.

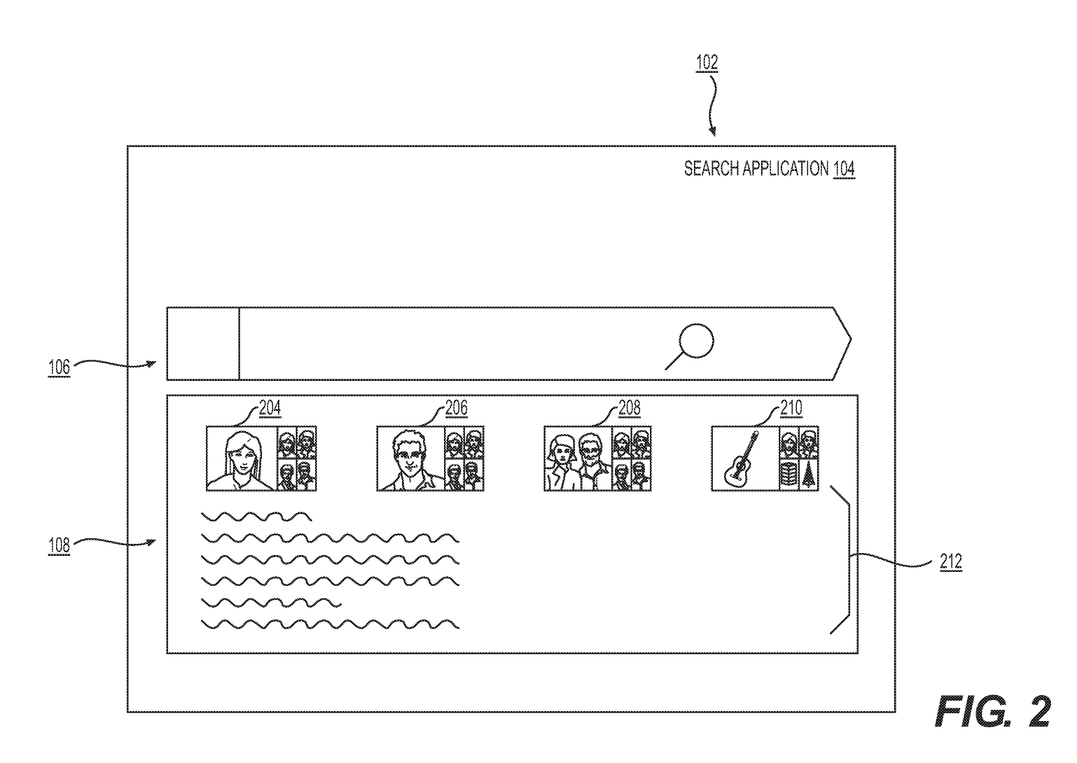

In order to fully appreciate implementations of the present technology, an example of the suggest window will be described in greater detail now. With reference to FIG. 2, there is depicted a screen shot of information displayed on the electronic device 102, much akin to the one in FIG. 1. The search application 104 includes the search query interface 106 and the search results interface 108. According to non-limiting embodiments of the present technology, there is also provided image-based search suggestions 204, 206, 208 and 210.

Generally speaking, image-based search suggestions 204, 206, 208 and 210 are presented in a distinct area of the search application 104. In some embodiments, the distinct area is at the top of the search result page or SERP 108, above the search results 212. However, in alternative embodiments of the present technology, the placement of the image-based search suggestions 204, 206, 208 and 210 can be different. By the same token, even though the image-based search suggestions 204, 206, 208 and 210 are depicted as all being displayed in a single distinct area, in alternative embodiments of the present technology, the image-based search suggestions 204, 206, 208 and 210 can be split into separate distinct areas and, in a sense, mixed with the rest of the information displayed within SERP 108.

In some embodiments of the present technology and as depicted in FIG. 2, the image-based search suggestions 204, 206, 208 and 210 are presented in a row at the top of the SERP 108 and just below the search query interface 106. In alternative non-limiting embodiments of the present technology, the image-based search suggestions 204, 206, 208 and 210 can be located differently relative to the search query interface 106 and the search results 212. For example, in alternative implementations, the image-based search suggestions 204, 206, 208 and 210 may be positioned next, above or below portions of the search query interface 106 and the search results 212, and the like.

In alternative non-limiting embodiments of the present technology, the image-based search suggestions 204, 206, 208 and 210 may replace a portion of the search application 104, one or both of the search query interface 106 and the search results 212.

In some embodiments of the present technology, the image-based search suggestions 204, 206, 208 and 210 appear the moment the user has typed enough of a search query into the search query interface 106 to enable image-based search suggestion processing, as will be described below. In other words, the image-based search suggestions 204, 206, 208 and 210 can appear automatically in a sense of not requiring the user to take any affirmative actions. Alternatively, it is possible that the image-based search suggestions 204, 206, 208 and 210 appear in response to the user positively indicating his or her intent to use image-based search suggestion function.

In the depicted illustrative embodiment, four image-based search suggestions are shown—a first image-based search suggestion 204, a second image-based search suggestion 206, a third image-based search suggestion 208, and a fourth image-based search suggestion 210. It should be expressly understood that the number of image-based search suggestions is not particularly limited. For example, in some embodiments of the present technology, a single row of image-based search suggestions is displayed, as depicted. In alternative non-limiting embodiments of the present technology, at least two or more rows of image-based search suggestions are displayed. Alternatively or additionally, the number of displayed image-based search suggestions can be dynamic, for example, based on the subject of the search query. In other words, as the suggestion module 142 generates additional alternatives for the image-based search suggestions, the number of suggestions displayed in the search results interface 108 can be dynamically increased. It should be expressly understood that neither the number of image-based search suggestions displayed on a single row nor the number of rows is particularly limited. Further, where at least two or more rows of image-based search suggestions are displayed, individual rows need not each include the same number of image-based search suggestions.

In some embodiments of the present technology and as depicted in FIG. 2, the first image-based search suggestion 204, the second image-based search suggestion 206, the third image-based search suggestion 208, and the fourth image-based search suggestion 210 each include five images, a larger image on the left side of the image-based search suggestion and four smaller images shown in a grid on the right side of the image-based search suggestion. In alternative non-limiting embodiments of the present technology, the image-based search suggestions 204, 206, 208, and 210 may include a smaller or larger number of images, for example, 1 image, 2 images, or more. Further, the number of images included in each of the image-based search suggestions 204, 206, 208, and 210 is independent from the number of images included in the others. For example, the first image-based search suggestion 204 may include 1 image, the second image-based search suggestion 206 may include 5 images, the third image-based search suggestion 208 may include 3 images, and the fourth image-based search suggestion 210 may include 5 images. It should be expressly understood that the number and format of images displayed in the image-based search suggestions 204, 206, 208, and 210 is not particularly limited.

For the purposes of illustration, it shall be assumed that a given user is interested in learning more about Macaulay Culkin. To that end, the given user has started entering a portion of a search query “Macaulay Culkin” into the search query interface 106. According to embodiments of the present technology and, as will be described in greater detail below, the server 116 is configured to cause the search application 104 to output image-based search suggestions 204, 206, 208 and 210. According to the non-limiting embodiments of the present technology, the server 116 causes the search application 104 to display the image-based search suggestions 204, 206, 208 and 210 below the search query interface 106.

Continuing with the example presented above, non-limiting implementations of the image-based search suggestions may include the following: The first image-based search suggestion 204 may include images of Macaulay Culkin's ex-wife. The second image-based search suggestion 206 may include images of Macaulay Culkin's brother. The third image-based search suggestion 208 may include images of a bearded Macaulay Culkin. The fourth image-based search suggestion 210 may include images of Macaulay Culkin's band. It will be appreciated that many other image-based search suggestions are possible.

Now, we will turn our attention to how the server 116 generates the above-mentioned examples of image-based search suggestion. When the user enters a portion of the search query into the search query interface 106, the server 116 is configured to acquire an indication of the portion of the search query over the communication link 112 and to transmit the portion of the search query to the suggestion module 142. The suggestion module 142 is configured to generate one or more of the image-based search suggestions. In one example of a non-limiting embodiment, the suggestion module 142 can access the above-mentioned vertical search module 124. In some embodiments, the suggestion module 142 may access a plurality of vertical search modules (not depicted). Then, the suggestion module 142 first generates a plurality of image-based search suggestions. How the suggestion module 142 generates the image-based search suggestions is not particularly limited and may include one or more of: (i) statistical popularity of a given image-based search suggestion based at least partially on past related search queries; (ii) user-specific popularity of the given image-based search suggestion; (iii) how often a particular image-based search suggestion is typically searched along with the search query; and (iv) other auxiliary information.

For example, in the above-provided example for search query “Macaulay Culkin”, image-based search suggestions may include suggestions for Macaulay Culkin movies, Macaulay Culkin career, Macaulay Culkin ex-wife, Macaulay Culkin girlfriend, Macaulay Culkin family, Macaulay Culkin birthplace, Macaulay Culkin hairstyle, as well as more distantly or implicitly related topics such as child actors, Christmas movies, Home Alone, celebrity bands, and the like. Image-based search suggestions may be directly related to the search query (for example, semantically related, obvious word additions, popular related topics, e.g., “Macaulay Culkin movies”) or may be indirectly linked to the search query (for example, topics having indirect connections to the search query, e.g., “Rachel Miner” (Macaulay Culkin's ex-wife), “Home Alone” (Macaulay Culkin's hit movie)). After the suggestion module 142 generates the plurality of image-based search suggestions, the image-based search suggestions are ranked and then displayed to the user in accordance with the present technology, as described further below.

Given the architecture described with reference to FIG. 1 and an example provided in FIG. 2, it is possible to execute a method of processing an image-based search suggestion for a search query. The method of processing an image-based search suggestion can be conveniently executed on the server 116. To that end, the server includes computer usable information storage medium storing computer instructions, which instructions when executed, cause the server 116 to execute steps of the method described herein below.

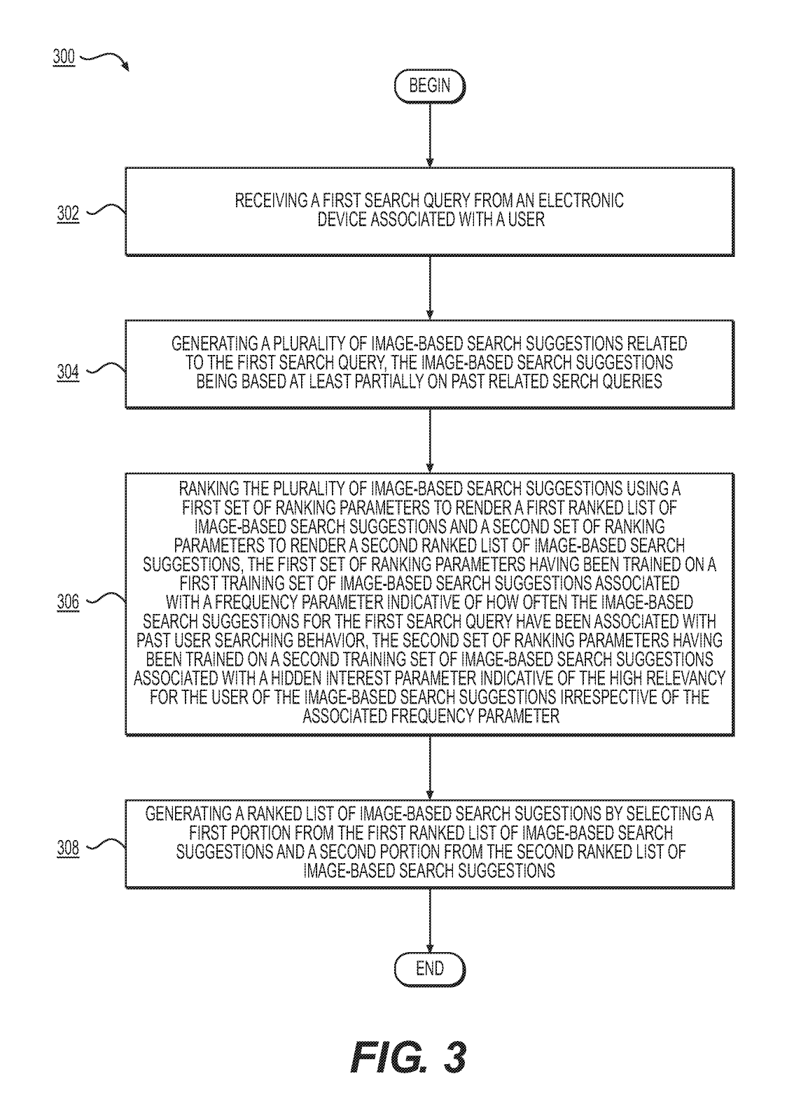

Reference will now be made to FIG. 3, which depicts a block diagram of a method 300, the method 300 being implemented in accordance with a non-limiting embodiment of the present technology.

Step 302—receiving a first search query from an electronic device associated with a user

The method 300 begins at step 302, where the server 116 receives a first search query from the electronic device 102 associated with the user. The step 302 is executed in response to the user entering a first search query or a portion of the first search query into the electronic device 102 using the search query interface 106 of the search application 104. As has been mentioned above, step 302 can be executed automatically, or the user may need to indicate his or her desire to implement step 302. The indication of the desire may be received in real time (for example, by the user clicking a dedicated button) or as part of setting or set up of the search application 104. The server 116 receives the portion of the first search query over the communication link 112.

In some non-limiting embodiments of the present technology, the first search query is transmitted to the server 116 as a standard URL (i.e., a link) encoded in HTML format. In other embodiments of the present technology, the first search query is transmitted in a MYSQ1 script. The latter is particularly useful in, but is not limited to, those non-limiting embodiments where the server 116 is implemented as an SQL server.

The method then proceeds to execution of step 304.

Step 304—generating a plurality of image-based search suggestions related to the first search query, the image-based search suggestions being based at least partially on past related search queries

The method 300 then proceeds to step 304, where the server 116 causes the suggest module 142 to generate a plurality of image-based search suggestions related to the first search query (or portion thereof), the image-based search suggestions based at least partially on past related search queries.

As has been described above, the suggestion module 142 can access the vertical search module 124 (or a plurality of vertical search modules). Continuing with the example provided herein, using the first search query “Macaulay Culkin” (or portion thereof) as an example, the suggestion module 142 may determine (based on some of the algorithms described above) that image-based search suggestions include Macaulay Culkin movies, Macaulay Culkin career, Home Alone, Macaulay Culkin ex-wife, Macaulay Culkin girlfriend, Macaulay Culkin family, Rachel Miner, Macaulay Culkin birthplace, Macaulay Culkin hairstyle, etc.

The method then proceeds to execution of step 306.

Step 306—ranking the plurality of image-based search suggestions using a first set of ranking parameters to render a first ranked list of image-based search suggestions and a second set of ranking parameters to render a second ranked list of image-based search suggestions, the first set of ranking parameters having been trained on a first training set of image-based search suggestions associated with a frequency parameter indicative of how often the image-based search suggestions for the first search query have been associated with past user searching behavior, the second set of ranking parameters having been trained on a second set of image-based search suggestions associated with a hidden interest parameter indicative of the high relevancy for the user of the image-based search suggestions irrespective of the associated frequency parameter

The method 300 then proceeds to execution of step 306, where the server 116 ranks the plurality of image-based search suggestions. As part of executing step 306, the server 116 uses a first set of ranking parameters to render a first ranked list of image-based search suggestions. As part of executing step 306, the server 116 also uses a second set of ranking parameters to render a second ranked list of image-based search suggestions.

In accordance with non-limiting embodiments of the present technology, the first set of ranking parameters have been trained on a training set of image-based search suggestions associated with a frequency parameter. Generally, the frequency parameter is indicative of how often the image-based search suggestions for the first search query have been associated with past user searching behavior. For example, the frequency parameter may be based on one or more of the following factors: click history (for example, frequency and/or duration of click throughs), popularity of past search queries, past searching behavior, number of past search queries, number of past sessions, size of past sessions, average time between queries, average position distance between queries, and the like.

In accordance with non-limiting embodiments of the present technology, the second set of ranking parameters have been trained on a training set of image-based search suggestions associated with a hidden interest parameter. Generally, the hidden interest parameter is indicative of the high relevancy for the user of the image-based search suggestions, irrespective of the associated frequency parameter. For example, an image-based search suggestion may have a very low frequency parameter based on a small click history, rarely having been searched in combination with the first search query, or general unpopularity of the search suggestion, based on past user searching behavior. Nevertheless, the image-based search suggestion may have a high hidden interest parameter based on other factors such as the relevance and/or interest to the user of the image-based search suggestion, the relationship between the image-based search suggestion and the first search query, the attractiveness of the search suggestion when displayed on the search result interface 108, and the like.

Continuing with the example, the fourth image-based search suggestion 210 (including images of Macaulay Culkin's band) may have a low frequency parameter if the band is new or not widely known. However, irrespective of the low frequency parameter, the band may have a high hidden interest parameter as it is of high interest for fans of Macaulay Culkin. As another example, an image-based search suggestion “Rachel Miner” may have a low frequency parameter as the name “Rachel Miner” is only indirectly linked to the name “Macaulay Culkin”, however the hidden interest parameter is high since Rachel Miner is Macaulay Caulkin's ex-wife.

The first and second sets of ranking parameters are trained on a training set of image-based search suggestions related to the first search query. A “training set” refers to a collection of user data referenced from past related search queries. Referenced user data in a training set are judged to determine how to rank image-based search suggestions. A training set of data may be judged by a human judge, also referred to herein as an “assessor”. An assessor may include a single human judge or multiple judges. Alternatively, a training set of data may be judged using a machine-learned model.

In some non-limiting embodiments of the present technology, ranking parameters are determined with respect to a single training set of user data for a single first search query. In alternative non-limiting embodiments, ranking parameters are determined with respect to multiple training sets of user data for the same first search query.

In some non-limiting embodiments of the present technology, the second set of ranking parameters associated with a hidden interest parameter is determined by an assessor. The assessor ranks search results based at least in part on past related search queries. In some implementations, the assessor ranks search results based on one or more factor selected from relationship between the image-based search suggestions and the first search query, interest to the user, attractiveness of the results from the search, attractiveness of the SERP 108, and the like. In some non-limiting implementations of the present technology, the assessor uses human-based judgments based on feedback from one or more human individuals to determine the second set of ranking parameters. Human-based judgments may include, for example, pre-determined user preferences based on past user searching behavior. In some non-limiting implementations, such human-based judgments are user-specific. In alternative non-limiting implementations, such human-based judgments are not user-specific, e.g., based on a statistical sampling of past users. In other alternative non-limiting implementations, human-based judgments are based on the assessor's judgment. For example, the assessor may judge that Macaulay Culkin's band is of high interest to his fans, despite the low popularity of the search suggestion as judged, for example, by click history. As another example, the assessor may judge the aesthetic qualities of the image-based search suggestion, based for example on color of the associated images and the visual impact on the SERP 108.

In some embodiments of the present technology, the hidden interest parameter is determined by assessors based on a “three thumbs up” algorithm. Just as an example, the assessor may be presented with a training set of search results for a given training search query. The assessor can then assign a label to each of the search results within the training set of search results. The assessor may assign a “single thumb up” label to those of the search results that are relevant to the given search query but are so obviously linked that they would have very little value to the user as a query suggestion. The assessor may assign a “double thumbs up” label to those of the search results that are relevant to the given search query, however, which link is not as clear as the link with the obviously linked results and, hence, there would be some value to use these search results for generating a query suggestion to the user. Finally, the assessor may assign a “triple thumbs up” label to those of the search results that are relevant to the given search query but are not obviously linked to the given search query and, therefore, can be said to be associated with the hidden interest link to the given search query.

In alternative non-limiting embodiments of the present technology, the second set of ranking parameters associated with a hidden interest parameter is determined by a machine-learned model. The machine-learned model ranks search results based at least in part on past related search queries. In some implementations, the machine-learned model ranks search results based on one or more factor selected from number of past search queries, number of past sessions, size of past sessions, average time between queries, average position distance between queries, click history, and the like.

Once the first and second ranked lists of image-based search suggestions have been rendered, using respectively the first and second sets of ranking parameters, the method 300 then proceeds to execution of step 308.

Step 308—generating a ranked list of image-based search suggestions by selecting a first portion from the first ranked list of image-based search suggestions and a second portion from the second ranked list of image-based search suggestions

The method 300 then executes step 308, where the server 116 generates a ranked list of image-based search suggestions by combining a first portion of the first ranked list and a second portion of the second ranked list, to generate a ranked list that includes a mix of the high frequency image-based search suggestions (from the first ranked list) and the high hidden interest image-based search suggestions (from the second ranked list).

In some non-limiting implementations of step 308, a pre-determined number of image-based search suggestions from each of the first and second ranked lists is selected for inclusion in the ranked list. For example, the top 3 image-based search suggestions from each of the first and second ranked lists may be chosen for inclusion in the ranked list. Alternatively, it may be predetermined that the top 4 image-based search suggestions from the second ranked list and the top 1 image-based search suggestion from the first ranked list are chosen for inclusion in the ranked list. It should be understood that the ratio of mixing image-based search suggestions is not particularly limited.

In some non-limiting implementations of step 308, the ranked list of image-based search suggestions is generated using an assessment parameter. The assessment parameter determines the proportion of the first portion and the second portion in the ranked list. As an example, in some embodiments the first portion is smaller than the second portion, so that the ranked list contains a majority of image-based search suggestions from the second ranked list associated with the hidden interest parameter. In alternative embodiments, the first portion is about the same size as the second portion, so that the ranked list contains approximately the same number of image-based search suggestions from the first and second ranked lists. In still further embodiments, the second portion is smaller than the first portion, so that the ranked list contains a majority of image-based search suggestions from the first ranked list associated with the frequency parameter. As an example, the ratio of search suggestions from the first to the second list may be 5 to 2, or 6 to 1. It should be understood that the proportion of the first portion and the second portion in the ranked list is not particularly limited.

In some non-limiting embodiments, the assessment parameter is determined by an assessor. The assessor ranks search results based at least in part on past related search queries. The assessor may rank search results based on one or more factor such as relationship between the image-based search suggestions and the first search query, interest to the user, attractiveness of the results from the search, attractiveness of the SERP 108, and the like. In some non-limiting embodiments, the assessment parameter determining the proportion of the first portion and the second portion is based at least in part on predetermined criteria, user interest, and/or past searching behavior.

In alternative non-limiting embodiments, the assessment parameter is determined using a machine-learned model for ranking search results, based at least in part on past related search queries. The machine-learned model for ranking search results may be based on one or more factor such as the number of past search queries, the number of past sessions, size of past sessions, the average time between queries, the average position distance between histories, click history and the like.

As discussed above for factors used to determine the first and second sets of ranking parameters, the factors used to generate the assessment parameter may be user-specific or, alternatively, may be statistical based on data from a sampling of users.

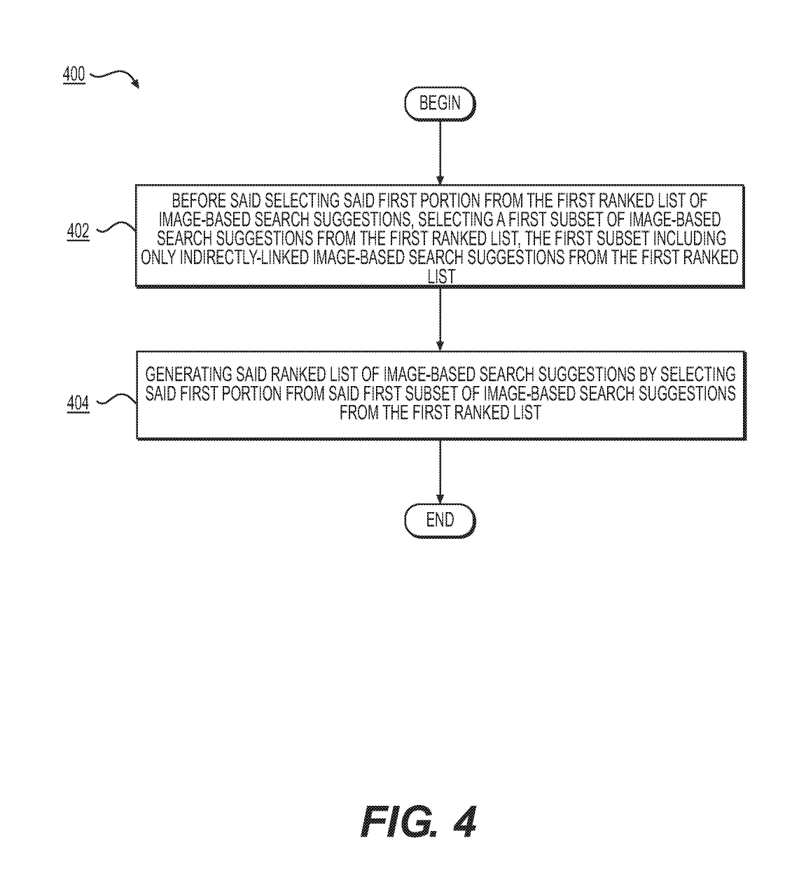

Reference will now be made to FIG. 4, which depicts a block diagram of a method 400, the method 400 being implemented in accordance with a non-limiting embodiment of the present technology.

The method 400 begins with steps 302-308, which have been described at length above. For ease of understanding, these steps are not depicted in FIG. 4, nor repeated here.

Step 402—before said selecting said first portion from the first ranked list of image-based search suggestions, selecting a first subset of image-based search suggestions from the first ranked list, the first subset including only indirectly-linked image-based search suggestions from the first ranked list

The method 400 adds a new step 402 to the method 300 described above. In the method 400, before selecting the first portion from the first ranked list of image-based search suggestions (in other words, before step 308), the server 116 executes step 402 of selecting a first subset of image-based search suggestions from the first ranked list. The first subset includes only indirectly-linked image-based search suggestions from the first ranked linked list. In other words, directly-linked image-based search suggestions are removed from the first ranked list to generate the first subset of image-based search suggestions.

In alternative non-limiting embodiments, a predetermined proportion of directly-linked and indirectly-linked image-based search suggestions is selected. In some embodiments, the first subset may contain a higher proportion of directly-linked image-based search suggestions, for example the ratio of directly-linked search suggestions to indirectly-linked search suggestions may be 5 to 2, or 6 to 1.

Directly-linked image-based search suggestions include search suggestions that are obviously or clearly related to the first search query. For example, directly-linked image-based search suggestions may be semantically linked to the first search query (e.g., obvious word additions, simple adjectives, polysemic variants) or directly associated topics (e.g., popular related topics, obvious extensions of the original theme). Continuing with the above example, “Macaulay Culkin movies” and “Macaulay Culkin wife” are examples of directly-linked image-based search suggestions.

In some non-limiting embodiments, the first subset excludes directly-linked image-based search suggestions. For example, the first subset may exclude directly-linked image-based search suggestions such as: queries that add words to the first search query; queries of multiple meanings of words in the first search query; queries to popular related topics; queries to popular products that include the first search query; queries to obvious extensions of a theme of the first search query; and queries that are semantically related to the first search query.

By contrast, indirectly-linked image-based search suggestions include search suggestions that are implicitly or distantly connected to the first search query. Such search suggestions may be difficult to associate with the first search query, despite their interest to a majority of users. Continuing with the above example, “Home Alone 2: Lost in New York” (a movie starring Macaulay Culkin) and “Rachel Miner” (Macaulay Culkin's ex-wife) are examples of indirectly-linked image-based search suggestions.

In some non-limiting embodiments, the first subset is selected using a machine-learned model based at least in part on an assessor's judgment of past related search queries. As mentioned above, an assessor may be a single human judge or a plurality of human judges. As has been mentioned above, the machine-learned algorithm can be trained to determine directly-linked and indirectly-linked image suggestions based on the above described three thumbs up algorithm

Step 404—generating said ranked list of image-based search suggestions by selecting said first portion from said first subset of image-based search suggestions from the first ranked list

The method 400 then proceeds to step 404 where the ranked list of image-based search suggestions is generated by selecting said first portion from the first subset of image-based search suggestions selected from the first ranked list in step 402. In other words, from the first ranked list (associated with the frequency parameter), only the top ranked indirectly-linked image-based search suggestions are included in the ranked list. It should be understood that in step 404, as in step 308 above, there is also selected a second portion from the second ranked list of image-based search suggestions (not depicted in FIG. 4). As in step 308 above, the ranked list of image-based search suggestions is generated by combining the first portion from the first subset of the first ranked list and the second portion from the second ranked list.

Just like in step 308, in step 404 a pre-determined number of image-based search suggestions from each of the first subset of the first ranked list and the second portion of the second ranked list may be selected for inclusion in the ranked list. It should be understood that the proportion of image-based search suggestions from the two lists is not particularly limited. In alternative non-limiting implementations of step 404, just like in step 308, the ranked list of image-based search suggestions is generated using an assessment parameter. The assessment parameter determines the proportion of the first subset and the second portion in the ranked list. As an example, in some embodiments the first subset is smaller than the second portion, so that the ranked list contains a majority of image-based search suggestions from the second ranked list associated with the hidden interest parameter. In alternative embodiments, the first subset is about the same size as the second portion, so that the ranked list contains approximately the same number of image-based search suggestions from the first and second ranked lists. It should be understood that the proportion of the first subset and the second portion in the ranked list is not particularly limited.

Just like in step 308, in some non-limiting embodiments, the assessment parameter is determined by an assessor. The assessor ranks search suggestions based at least in part on past related search queries. The assessor may rank search suggestions based on one or more factor such as relationship between the image-based search suggestions and the first search query, interest to the user, attractiveness of the results from the search, attractiveness of the SERP 108, and the like. In alternative non-limiting embodiments, the assessment parameter is determined using a machine-learned model for ranking search results, based at least in part on past related search queries. The machine-learned model for ranking search results may be based on one or more factor such as the number of past search queries, the number of past sessions, size of past sessions, the average time between queries, the average position distance between histories, click history and the like. The factors used to generate the assessment parameter may be user-specific or, alternatively, may be statistical based on data from a sampling of users.

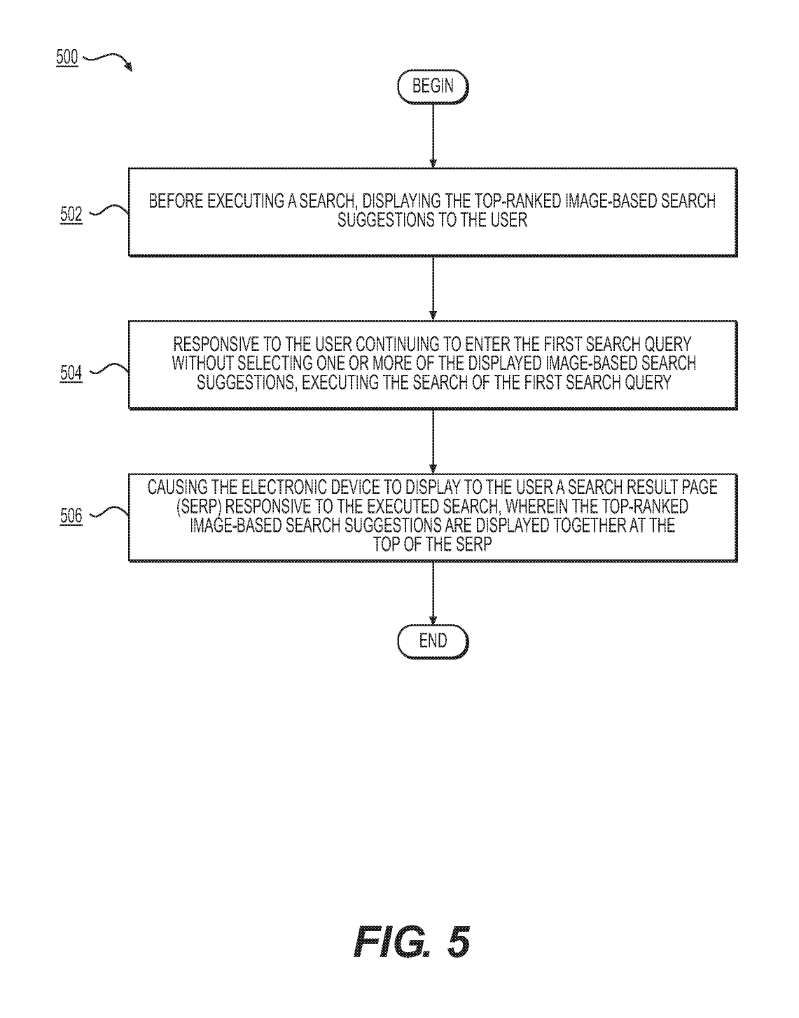

Reference will now be made to FIG. 5, which depicts a block diagram of a method 500, the method 500 being implemented in accordance with a non-limiting embodiment of the present technology.

The method 500 begins with steps 302-308, which have been described at length above. For ease of understanding, these steps are not depicted in FIG. 5, nor repeated here.

Step 502—before executing a search, displaying the top-ranked image-based search suggestions to the user

The method 500 continues with step 502. In step 502, before a search is executed in response to the first search query, the top-ranked image-based search suggestions are displayed to the user.

In some non-limiting implementations of the present technology, the top-ranked image-based search suggestions are displayed to the user while the user is entering the first search query. For example, the user may have entered only a partial first search query, or may be in the process of entering the first search query. Continuing with the above example, the user may have entered only “Macaulay” in the search query interface 106. In alternative non-limiting implementations, the top-ranked image-based search suggestions are displayed to the user after the user has completed entering the first search query, but before the search has been executed. For example, the user has entered “Macaulay Culkin” in the search query interface 106, but the search has not yet been executed.

It should be expressly understood that the display of the top-ranked image-based search suggestions to the user is not particularly limited. For example, the number, the location, and the format of the top-ranked image-based search suggestions are not limited. In the illustrative embodiment shown in FIG. 2, four image-based search suggestions 204, 206, 208, and 210 are displayed at the top of the SERP 108 in a horizontal row under the search query interface 106, each of the image-based search suggestions 204, 206, 208, and 210 including one large and four small images. However, as discussed above, this embodiment is depicted for illustrative purposes only and many other displays are possible.

Step 504—responsive to the user continuing to enter the first search query without selecting one or more of the displayed image-based search suggestions, executing the search of the first search query

The method 500 continues with step 504. After the top-ranked image-based search suggestions are displayed to the user, the user has the choice of continuing with the first search query, or of deciding to search instead for one of the image-based search suggestions. In step 504, responsive to the user deciding to continue with the first search query, the server 116 executes the search of the first search query.

Step 506—causing the electronic device to display to the user a search result page (SERP) responsive to the executed search, wherein the top-ranked image-based search suggestions are displayed together at the top of the SERP

The method 500 continues with step 506. After the server 116 has executed the search of the first search query in step 504, the electronic device 102 displays to the user a search result page (SERP) 108 responsive to the executed search. The search results 212 are displayed in the SERP 108.

It should be expressly understood that the nature of the first search query and the search results 212 is not particularly limited. In the illustrative embodiment depicted in FIG. 2, the search results 212 are general search results. Alternatively, in other embodiments, the search results 212 can be vertical search results, i.e., search results from a vertical domain such as images.

Regardless of the type of search results 212 displayed in the SERP 108, the top-ranked image-based search suggestions 204, 206, 208, and 210 are displayed together at the top of the SERP 108.

The illustrative embodiments depicted in FIGS. 2 and 5 show the image-based search suggestions 204, 206, 208, and 210 displayed together in a horizontal row at the top of the SERP 108, above the search results 212, and beneath the search query interface 106. However, it should be expressly understood that the display is not particularly limited and other displays are possible, as discussed at length above.

In the embodiment illustrated in FIG. 5, the user decides to continue with the first search query, as shown in the method 500. In alternative non-limiting embodiments of the present technology, the user decides not to continue with the first search query and to search instead for one of the image-based search suggestions. In such alternative embodiments, after step 502, the user selects one or more of the displayed image-based search suggestions. For example, the user clicks on one of the displayed image-based search suggestions. Responsive to the user selecting (e.g., clicking on) one or more of the displayed image-based search suggestions, the server 116 executes a search of the selected image-based search suggestion and causes the electronic device 102 to display to the user a SERP 108 responsive to the executed search. In some embodiments, the remaining top-ranked image-based search suggestions (i.e., the top-ranked image-based search suggestions not selected by the user) are displayed together at the top of the SERP 108, just like in step 506.

It will be appreciated that more than one step of the above methods described herein above includes an assessor. It should be expressly understood that in each step the assessor is selected independently. In other words, the same or different assessor may perform each of the required steps, i.e., a first assessor may or may not be the same as a second assessor, who may or may not be the same as a third assessor, and so on.

Some technical effects of non-limiting embodiments of the present technology may include provision of infrequent or unpopular, but nevertheless high interest, image-based search suggestions to the user, in response to the user entering the first search query or a portion thereof. This provision of search suggestions can allow the user to delve more deeply into a subject of interest. This provision may further allow the user to find more efficiently the information he or she is expressly looking for or information he or she may be explicitly looking for (through the hidden interest parameter). Ability for the user to more efficiently find information results in less bandwidth usage. Also, with the electronic device 102 being implemented as a wireless communication device, ability to more efficiently find information would result in conservation of battery power of the electronic device 102. It can also provide the user with a more attractive or interesting search interface or search results page. It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of processing an image-based search suggestion for a first search query, the method executable at a server, the method comprising:
receiving the first search query from an electronic device associated with a user;
generating a plurality of image-based search suggestions related to the first search query, the image-based search suggestions being based at least partially on past related search queries;
ranking the plurality of image-based search suggestions using a first set of ranking parameters to render a first ranked list of image-based search suggestions, the first set of ranking parameters having been trained on a first training set of image-based search suggestions associated with a frequency parameter indicative of how often the image-based search suggestions for the first search query have been associated with past user searching behavior;
ranking the plurality of image-based search suggestions using a second set of ranking parameters to render a second ranked list of image-based search suggestions, the second set of ranking parameters having been trained on a second training set of image-based search suggestions associated with a hidden interest parameter indicative of the high relevancy for the user of the image-based search suggestions irrespective of the associated frequency parameter,
the first ranked list and the second ranked list each having the plurality of the image-based search suggestions ranked differently;
based on an assessment parameter selecting a first number of top-ranked image-based search suggestions from the first ranked list of image-based search suggestions for a first portion of a ranked list of image-based search suggestions, the first portion containing fewer image-based search suggestions than the first ranked list of image-based search suggestions;
based on the assessment parameter selecting a second number of top-ranked image-based search suggestions from the second ranked list of image-based search suggestions for a second portion of the ranked list of image-based search suggestions, the second portion containing fewer image-based search suggestions than the second ranked list of image-based search suggestions;
the assessment parameter being indicative of a proportion of a number of image-based suggestions from the first portion and a number of image-based suggestions from the second portion in the ranked list of image-based search suggestions;
generating the ranked list of image-based search suggestions containing image-based suggestions from the first portion and the second portion.

2. The method of claim 1, further comprising:
before said selecting said first portion from the first ranked list of image-based search suggestions, selecting a first subset of image-based search suggestions from the first ranked list, the first subset including only indirectly-linked image-based search suggestions from the first ranked list; and
generating said ranked list of image-based search suggestions by selecting said first portion from said first subset of image-based search suggestions from the first ranked list.

3. The method of claim 2, wherein said first subset is selected using a first machine-learned model based at least in part on a first assessor's judgment of said past related search queries.

4. The method of claim 2, wherein said first subset excludes directly-linked image-based search suggestions selected from: queries that add words to the first search query; queries of multiple meanings of words in the first search query; queries to popular related topics; queries to popular products that include the first search query; queries to obvious extensions of a theme of the first search query; and queries that are semantically related to the first search query.

5. The method of claim 1, further comprising:
before executing a search, displaying the top-ranked image-based search suggestions to the user;
responsive to the user continuing to enter the first search query without selecting one or more of the displayed image-based search suggestions, executing the search of the first search query; and
causing the electronic device to display to the user a search result page (SERP) responsive to the executed search, wherein the top-ranked image-based search suggestions are displayed together at the top of the SERP.

6. The method of claim 1, further comprising:
before executing a search, displaying the top-ranked image-based search suggestions to the user;
responsive to the user selecting one or more of the displayed image-based search suggestions, executing the search of the selected image-based search suggestions; and
causing the electronic device to display to the user a search result page (SERP) responsive to the executed search.

7. The method of claim 6, wherein the top-ranked image-based search suggestions not selected by the user are displayed together at the top of the SERP.

8. The method of claim 1, wherein said hidden interest parameter is determined by a second assessor ranking search results based at least in part on said past related search queries.

9. The method of claim 8, wherein said ranking search results by said second assessor is based on one or more factor selected from attractiveness of the results from the search, attractiveness of the SERP, relationship between the image-based search suggestions and the first search query, and interest to the user.

10. The method of claim 1, wherein said hidden interest parameter is determined using a second machine-learned model for ranking search results based at least in part on past related search queries.

11. The method of claim 10, wherein said second machine-learned model for ranking search results is based on one or more factor selected from number of past search queries, number of past sessions, size of past sessions, average time between queries, average position distance between queries, and click history.

12. The method of claim 11, wherein said one or more factor is user-specific.

13. The method of claim 11, wherein said one or more factor is statistical.

14. The method of claim 1, wherein said method is executed automatically upon receiving the first search query.

15. The method of claim 1, wherein said method is executed upon appreciation of an affirmative desire from the user to execute said method.

16. (canceled)

17. The method of claim 1, wherein said first portion is smaller than said second portion in said ranked list of image-based search suggestions.

18.-19. (canceled)

20. The method of claim 1, wherein:
said assessment parameter is determined by a third assessor ranking search results based at least in part on past related search queries; and
said third assessor ranks search results based on one or more factor selected from attractiveness of the results from the search, attractiveness of the SERP, relationship between the image-based search suggestions and the first search query, and interest to the user.

21. (canceled)

22. The method of claim 1, wherein said assessment parameter is determined using a third machine-learned model for ranking search results based at least in part on past related search queries.

23. The method of claim 22, wherein said third machine-learned model for ranking search results is based on one or more factor selected from number of past search queries, number of past sessions, size of past sessions, average time between queries, average position distance between queries, and click history.

24.-25. (canceled)

26. A server comprising:
a communication interface for communication with an electronic device associated with a user via a communication network;
a memory storage;
a processor operationally connected with the communication interface and the memory storage, the processor configured to store objects, in association with the user, on the memory storage, the processor being further configured to:
receive a first search query from the electronic device;
generate a plurality of image-based search suggestions related to the first search query, the image-based search suggestions being based at least partially on past related search queries;
rank the plurality of image-based search suggestions using a first set of ranking parameters to render a first ranked list of image-based search suggestions, the first set of ranking parameters having been trained on a first training set of image-based search suggestions associated with a frequency parameter indicative of how often the image-based search suggestions for the first search query have been associated with past user searching behavior
rank the plurality of image-based search suggestions using a second set of ranking parameters to render a second ranked list of image-based search suggestions, the second set of ranking parameters having been trained on a second training set of image-based search suggestions associated with a hidden interest parameter indicative of the high relevancy for the user of the image-based search suggestions irrespective of the associated frequency parameter,
the first ranked list and the second ranked list each having in the plurality of the image-based search suggestions being ranked differently;
based on an assessment parameter select a first number of top-ranked image-based search suggestions from the first ranked list of image-based search suggestions for a first portion of a ranked list of image-based search suggestions, the first portion containing fewer image-based search suggestions than the first ranked list of image-based search suggestions;
based on the assessment parameter select a second number of top-ranked image-based search suggestions from the second ranked list of image-based search suggestions for a second portion of the ranked list of image-based search suggestions, the second portion containing fewer image-based search suggestions than the second ranked list of image-based search suggestions;
the assessment parameter being indicative of a proportion of a number of image-based suggestions from the first portion and a number of image-based suggestions from the second portion in the ranked list of image-based search suggestions;
generate the ranked list of image-based search suggestions containing image-based suggestions from the first portion and the second portion.

27-60. (canceled)
